(19) United States
(12) Patent Application Publication
(10) Pub. No.: US 2021/0171104 A1
(43) Pub. Date: Jun. 10, 2021

(54) ADAPTIVE CHASSIS AND ROBOT

(71) Applicant: NINEBOT (BEIJING) TECH. CO., LTD, Beijing (CN)

(72) Inventors: Weining XI, Beijing (CN); Xin HOU, Beijing (CN); Qiming WANG, Beijing (CN); Bin SHEN, Beijing (CN)

(21) Appl. No.: 16/768,742

(22) PCT Filed: Jul. 25, 2018
(86) PCT No.: PCT/CN2018/097075

§ 371 Date: Jun. 1, 2020

(30) Foreign Application Priority Data
Mar. 8, 2018 (CN) 201810191643.7

(51) Int. Cl. B62D 21/11; B62D 61/10; B25J 5/00; B60G 5/01; B60G 17/0165

(52) U.S. Cl. CPC B62D 21/11; B62D 61/10; B60G 2800/21; B60G 5/01; B60G 17/0165; B25J 5/007

(57) ABSTRACT

Disclosed are an adaptive chassis and a robot. The chassis includes: a support (110), a first wheel (101) and a second wheel (102) arranged at two sides of a first end of the support (110), a first suspension seat (120) arranged at a bottom side of a second end of the support (110), a first rotating shaft (121) arranged on the first suspension seat (120), a first crossbeam (130) connected with the first rotating shaft (121) and being capable of rotating around the first rotating shaft (121), and a third wheel (103) and a fourth wheel (104) arranged on two ends of the first crossbeam (130). An axis of the first rotating shaft (121) is consistent with a moving direction of the chassis. When a state of a supporting surface changes and one of the third wheel (103) and the fourth wheel (104) gets out of contact with the supporting surface, the out-of-contact one of the third wheel (103) and the fourth wheel (104) can rotate around the first rotating shaft (121) by means of the first crossbeam (130) to make contact with the supporting surface.

### CROSS-REFERENCE TO RELATED APPLICATION

The present application is based upon and claims priority to Chinese patent application No. 201810191643.7 filed on Mar. 8, 2018, the disclosure of which is hereby incorporated by reference in its entirety.

### TECHNICAL FIELD

The present disclosure relates to the technology of chassis, and in particular to an adaptive chassis and a robot.

### BACKGROUND

A chassis is an important part of a vehicle, and the vehicle moves on a supporting surface through wheels on the chassis. Common vehicles are provided with multiple wheels, so that the vehicles and objects carried by the vehicles may be supported by the multiple wheels, thus the pressure on each wheel may be reduced. The chassis in the prior art is typically provided with four wheels, and the chassis is supported by the four wheels. However, if the chassis is rigidly supported by four wheels, an over-positioning phenomenon will occur, which causes one of the four wheels to get out of contact with the supporting surface. If the wheel gets out of contact with or in virtual contact with the supporting surface is a driving wheel, the vehicle is prone to control overshoot, which affects the running stability of the vehicle, and even affects the security.

### SUMMARY

To solve the above technical problems, embodiments of the present disclosure provide an adaptive chassis and a robot.

The technical solutions of the embodiments of the present disclosure are as follows.

The embodiments of the present disclosure provide a chassis. The chassis includes: a support, a first wheel and a second wheel arranged at two sides of a first end of the support, a first suspension seat arranged at the bottom side of the second end of the support, a first rotating shaft arranged on the first suspension seat, a first crossbeam connected with the first rotating shaft and being capable of rotating around the first rotating shaft, and a third wheel and a fourth wheel arranged on two ends of the first crossbeam.

An axis of the first rotating shaft is consistent with a moving direction of the chassis.

When a state of a supporting surface changes and one of the third wheel and the fourth wheel gets out of contact with the supporting surface, the out-of-contact one of the third wheel and the fourth wheel can rotate around the first rotating shaft by means of the first crossbeam to make contact with the supporting surface.

In some optional implementation modes, the chassis further includes a first plate spring. A middle of the plate spring is fixed on the first suspension seat. The two sides of the first crossbeam with respect to the first suspension seat are respectively provided with a first position limiting seat and a second position limiting seat. The first position limiting seat is provided with a first through groove mating with a first end of the first plate spring, and the second position limiting seat is provided with a second through groove mating with a second end of the first plate spring.

The first end of the first plate spring is inserted in the first through groove and is capable of sliding in the first through groove. The second end of the first plate spring is inserted in the second through groove and is capable of sliding in the second through groove.

In some optional implementation modes, the first wheel and the second wheel are driving wheels, and the third wheel and the fourth wheel are driven wheels; or

the third wheel and the fourth wheel are the driving wheels, and the first wheel and the second wheel are the driven wheels; or

all of the first wheel, the second wheel, the third wheel and the fourth wheel are the driving wheels.

In some optional implementation modes, each driven wheel is a universal wheel, and a middle of each driving wheel is provided with a wheel hub motor.

In some optional implementation modes, a connecting seat is arranged at a top side of the support, a connecting shaft being arranged on the connecting seat, and an axis of the connecting shaft being vertical to the axis of the first rotating shaft.

The chassis further includes a supporting bracket. There is a wheel set arranged on a rear end of the supporting bracket, and a middle of the supporting bracket is connected with the connecting shaft and is capable of rotating around the connecting shaft.

When the support pulls, by means of the connecting shaft, the supporting bracket to move over the supporting surface, the wheel set rotates around the connecting shaft by means of the supporting bracket to make contact with the supporting surface.

In some optional implementation modes, the connecting seat includes a first connecting seat and a second connecting seat arranged at opposite sides of the top side of the support. The connecting shaft includes a first connecting shaft arranged on the first connecting seat and a second connecting shaft arranged on the second connecting seat. The axis of the first connecting shaft is vertical to an axis of the first rotating shaft; and an axis of the first connecting shaft is collinear with an axis of the second connecting shaft.

Two sides of the middle of the supporting bracket are respectively provided with a first connecting hole mating with the first connecting shaft and a second connecting hole mating with the second connecting shaft. The first connecting shaft is arranged in the first connecting hole, and the first connecting shaft is in clearance fit with the first connecting hole. The second connecting shaft is arranged in the second connecting hole, and the second connecting shaft is in clearance fit with the second connecting hole.

When the support pulls, by means of the first connecting shaft and the second connecting shaft, the supporting bracket to move over the supporting surface, the wheel set rotates around the first connecting shaft and the second connecting shaft by means of the supporting bracket to make contact with the supporting surface.

In some optional implementation modes, the chassis further includes a second plate spring and a third plate spring.

A middle of the second plate spring is fixed on the first connecting seat. Two sides of the supporting bracket with respect to the first connecting seat are respectively provided with a third position limiting seat and a fourth position limiting seat. The third position limiting seat is provided with a third through groove mating with a first end of the second plate spring, and the fourth position limiting seat is provided with a fourth through groove mating with a second end of the second plate spring. The first end of the second plate spring is inserted in the third through groove and is capable of sliding in the third through groove, and the second end of the second plate spring is inserted in the fourth through groove and is capable of sliding in the fourth through groove.

A middle of the third plate spring is fixed on the second connecting seat. Two sides of the supporting bracket with respect to the second connecting seat are respectively provided with a fifth position limiting seat and a sixth position limiting seat. The fifth position limiting seat is provided with a fifth through groove mating with a first end of the third plate spring, and the sixth position limiting seat is provided with a sixth through groove mating with a second end of the third plate spring. The first end of the third plate spring is inserted in the fifth through groove and is capable of sliding in the fifth through groove, and the second end of the third plate spring is inserted in the sixth through groove and is capable of sliding in the sixth through groove.

In some optional implementation modes, the first connecting seat and the second connecting seat are respectively at opposite sides of a top side of the second end of the support, a front end of the supporting bracket is correspondingly at a top side of the first end of the support, and the third wheel and the fourth wheel are arranged at the middle of the supporting bracket; or,

the first connecting seat and the second connecting seat are respectively at the opposite sides of the top side of the first end of the support, the front end of the supporting bracket is correspondingly at the top side of the second end of the support, and the first wheel and the second wheel are arranged at the middle of the supporting bracket.

In some optional implementation modes, the wheel set includes a fifth wheel and a sixth wheel. The third wheel and the fourth wheel arranged at the middle of the supporting bracket are the driving wheels, and the first wheel, the second wheel, the fifth wheel and the sixth wheel are the driven wheels. Distances from a center between the third wheel and the fourth wheel to the first wheel, the second wheel, the fifth wheel and the sixth wheel are equal, and the center between the third wheel and the fourth wheel is at an intersection of two diagonals formed by the first wheel, the second wheel, the fifth wheel and the sixth wheel; or

the first wheel and the second wheel arranged at the middle of the supporting bracket are the driving wheels, and the third wheel, the fourth wheel, the fifth wheel and the sixth wheel are the driven wheels; distances from a center between the first wheel and the second wheel to the third wheel, the fourth wheel, the fifth wheel and the sixth wheel are equal, and the center between the first wheel and the second wheel is at an intersection of two diagonals formed by the third wheel, the fourth wheel, the fifth wheel and the sixth wheel.

In some optional implementation modes, the chassis further includes a second suspension seat arranged at a bottom side of the rear end of the supporting bracket, a second rotating shaft arranged on the second suspension seat, and a second crossbeam connected with the second rotating shaft and being capable of rotating around the second rotating shaft; the wheel set includes a fifth wheel and a sixth wheel arranged on two ends of the second crossbeam.

An axis of the second rotating shaft is consistent with the moving direction of the chassis.

When the support pulls, by means of the connecting shaft, the supporting bracket to move over the supporting surface, and when the state of the supporting surface changes and one of the fifth wheel and the sixth wheel gets out of contact with the supporting surface, the out-of-contact one of the fifth wheel and the sixth wheel can rotate around the second rotating shaft by means of the second crossbeam to make contact with the supporting surface.

In some optional implementation modes, the chassis further includes a supporting plate arranged at the bottom side of the rear end of the supporting bracket, and an accommodating space arranged at a top side of the supporting plate.

The second suspension seat is arranged at the top side of the supporting plate and in the accommodating space. Positions, corresponding to the fifth wheel and the sixth wheel, of the supporting plate are respectively provided with openings. The fifth wheel and the sixth wheel are at the bottom side of the supporting plate after passing through respective openings; and the second crossbeam can rotate in the accommodating space around the second rotating shaft.

In some optional implementation modes, the chassis further includes position limiting slots arranged at the bottom side of the rear end of the supporting bracket and respectively mating with two ends of the second crossbeam. The two ends of the second crossbeam are inserted in respective position limiting slots, and preset clearances are formed between the two ends of the second crossbeam and the respective position limiting slots in a rotating direction of the second crossbeam.

When the second crossbeam rotates in the accommodating space around the second rotating shaft, the two ends of the second crossbeam limit a rotation angle of the second crossbeam by means of the position limiting slots.

The embodiments of the present disclosure also provide a robot. The robot includes the adaptive chassis recorded in the embodiments of the present disclosure.

In the embodiments of the present disclosure, when the state of the supporting surface changes and one of the third wheel and the fourth wheel gets out of contact with the supporting surface, the out-of-contact one of the third wheel and the fourth wheel can rotate around the first rotating shaft by means of the first crossbeam to make contact with the supporting surface. The embodiments solve the problem of over-positioning phenomenon occurring between the chassis rigidly supported by four wheels and the supporting surface, so that the four wheels can contact with the supporting surface in the moving process, thus the running stability and security of the vehicle in moving is improved.

### BRIEF DESCRIPTION OF THE DRAWINGS

FIG. 1 illustrates a schematic diagram of an optional structure of a chassis according to an embodiment of the present disclosure.

FIG. 2 illustrates a schematic diagram of another optional structure of a chassis according to an embodiment of the present disclosure.

FIG. 3 illustrates a partial diagram of another optional structure of a chassis according to an embodiment of the present disclosure.

FIG. 4 illustrates a schematic diagram of an optional structure of a fifth position limiting seat in a chassis according to an embodiment of the present disclosure.

FIG. 5 illustrates a schematic diagram of another optional structure of a chassis according to an embodiment of the present disclosure.

FIG. 6 illustrates a schematic diagram of an optional structure of a supporting bracket in a chassis according to an embodiment of the present disclosure.

FIG. 7 illustrates a schematic diagram of another optional structure of a chassis according to an embodiment of the present disclosure.

FIG. 8 illustrates a partial view of another optional structure of a chassis according to an embodiment of the present disclosure.

FIG. 9 illustrates a schematic diagram of another optional structure of a supporting bracket in a chassis according to an embodiment of the present disclosure.

FIG. 10 illustrates a schematic diagram of another optional structure of a supporting bracket in a chassis according to an embodiment of the present disclosure.

FIG. 11 illustrates a schematic diagram of another optional structure of a supporting bracket in a chassis according to an embodiment of the present disclosure.

Reference numbers in the accompanying drawings are as follows: 110 support; 101 first wheel; 102 second wheel; 103 third wheel; 104 fourth wheel; 120 first suspension seat; 121 first rotating shaft; 130 first crossbeam; 140 first plate spring; 141 first position limiting seat; 142 second position limiting seat; 143 first through groove; 144 second through groove; 150 supporting bracket; 151 fifth wheel; 152 sixth wheel; 153 clamping hook; 154 second suspension seat; 155 second rotating shaft; 156 second crossbeam; 157 supporting plate; 158 opening; 159 position limiting slot; 160 second connecting seat; 161 second connecting shaft; 170 third plate spring; 171 fifth position limiting seat; 172 sixth position limiting seat; 173 fifth through groove; 174 sixth through groove; 180 first connecting seat; and 181 first connecting shaft.

### DETAILED DESCRIPTION

The present disclosure is further elaborated below in combination with the accompanying drawings and specific embodiments. It should be understood that the specific embodiments described here are only used for explaining the present disclosure, but not for limiting the present disclosure.

In the embodiments of the present disclosure, it is to be noted that unless otherwise definitely specified and limited, the term “connection” should be broadly understood. For example, the term may refer to electrical connection, and may refer to communication in two components. The term may refer to direct connection, may also refer to indirect connection through a medium. For those of ordinary skill in the art, specific meanings of the term can be understood according to a specific condition.

It is to be noted that the terms “first/second/third” in the embodiments of the present disclosure are only used for distinguishing similar objects rather than representing a specific sequence of the objects. Understandably, a particular order or sequence of the terms “first/second/third” may be interchanged if permitted. It should be understood that the objects distinguished by “first/second/third” may be exchanged under appropriate circumstances, so that the embodiments of the present disclosure described here may be implemented in an order different from that described or shown herein.

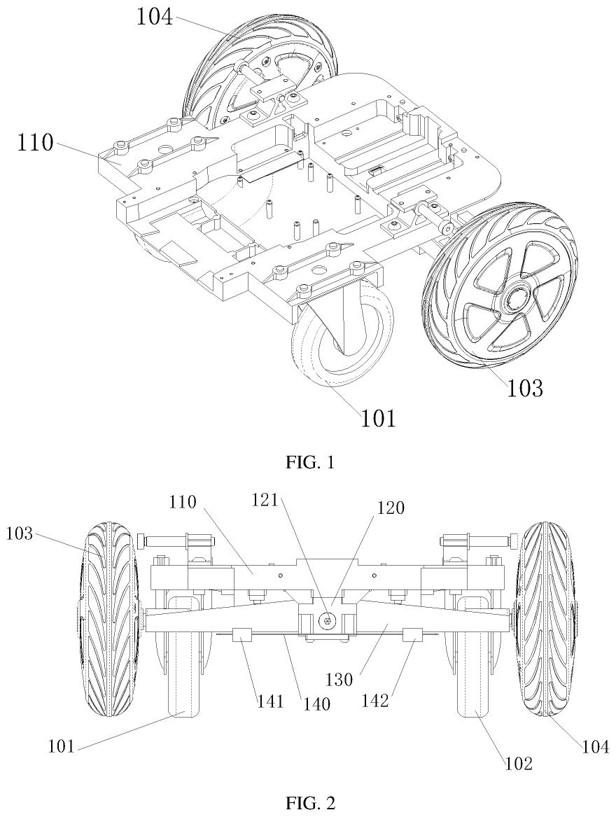

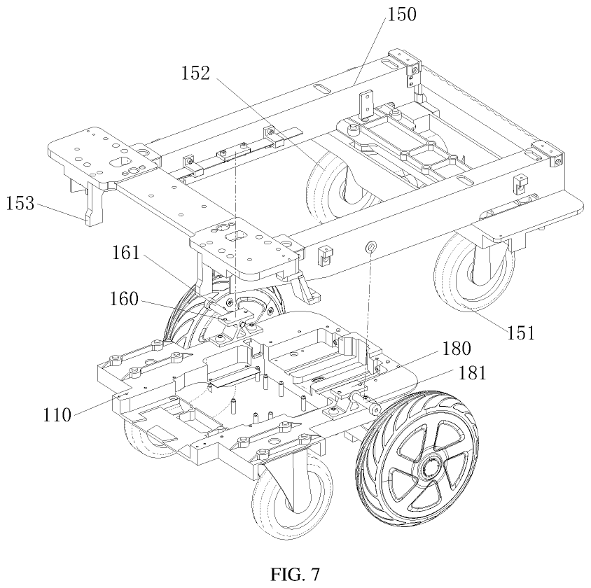

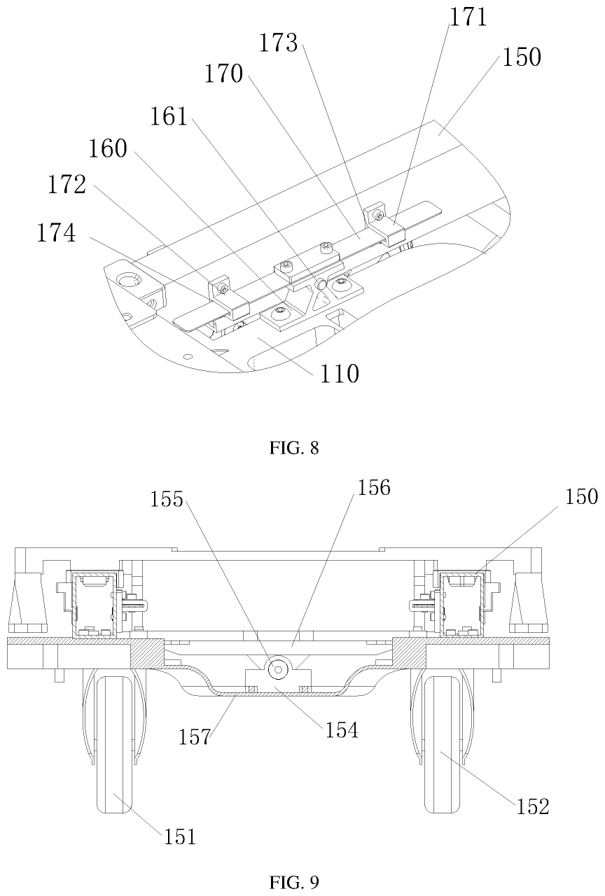

The embodiments of the present disclosure provide an adaptive chassis. The chassis in the embodiments of the present disclosure is elaborated below with reference to FIG. 1 to FIG. 8.

As illustrated in FIG. 1 and FIG. 2, the chassis provided by the embodiments of the present disclosure includes: a support 110, a first wheel 101 and a second wheel 102 arranged at two sides of a first end of the support 110, a first suspension seat 120 arranged at the bottom side of the second end of the support 110, a first rotating shaft 121 arranged on the first suspension seat 120, a first crossbeam 130 connected with the first rotating shaft 121 and being capable of rotating around the first rotating shaft 121, and a third wheel 103 and a fourth wheel 104 arranged on two ends of the first crossbeam 130. The axis of the first rotating shaft 121 is consistent with the moving direction of the chassis. When the state of a supporting surface changes and one of the third wheel 103 and the fourth wheel 104 gets out of contact with the supporting surface, the out-of-contact one of the third wheel 103 and the fourth wheel 104 can rotate around the first rotating shaft 121 by means of the first crossbeam 130 to make contact with the supporting surface.

In the embodiment, as shown in FIG. 2, the axis of the first rotating shaft 121 is consistent with the moving direction of the chassis, when the state of the supporting surface changes and one of the third wheel 103 and the fourth wheel 104 gets out of contact with the supporting surface, the out-of-contact one of the third wheel 103 and the fourth wheel 104 can rotate around the first rotating shaft 121 by means of the first crossbeam 130 to make contact with the supporting surface, so the problem of over-positioning of the chassis rigidly supported by four wheels may be solved, and it is ensured that the four wheels of the chassis contact with the supporting surface in the moving process.

Those skilled in the art should understand that the first end of the support 110 may be at the front side of the chassis, and may also be at the rear side of the chassis. When the first end of the support 110 is at the front side of the chassis, the second end of the support 110 is at the rear side of the chassis; correspondingly, the first wheel 101 and the second wheel 102 are at the front side of the chassis, and the third wheel 103 and the fourth wheel 104 are at the rear side of the chassis. When the first end of the support 110 is at the rear side of the chassis, the second end of the support 110 is at the front side of the chassis; correspondingly, the first wheel 101 and the second wheel 102 are at the rear side of the chassis, and the third wheel 103 and the fourth wheel 104 are at the front side of the chassis. The direction from the rear side of the chassis to the front side of the chassis is the direction of moving forward of the chassis, and the direction from the front side of the chassis to the rear side of the chassis is the direction of moving backward of the chassis.

The first wheel 101 and the second wheel 102 in the embodiment may be the driving wheels, and may also be the driven wheels. When the first wheel 101 and the second wheel 102 are the driving wheels, the third wheel 103 and the fourth wheel 104 are the driven wheels; when the third wheel 103 and the fourth wheel 104 are the driving wheels, the first wheel 101 and the second wheel 102 are the driven wheels. As an example, the driven wheel here may be a universal wheel, and the middle of the driving wheel may be provided with a wheel hub motor, so the chassis may be driven by means of the wheel hub motor provided in the middle of the driving wheel, and the change of the moving direction of the chassis may be flexibly adapted by means of the universal wheel. FIG. 1 and FIG. 2 exemplarily illustrate that the first wheel 101 and the second wheel 102 are the universal wheels, and the third wheel 103 and the fourth wheel 104 are the driving wheels. Certainly, all of the first wheel 101, the second wheel 102, the third wheel 103 and the fourth wheel 104 may be the driving wheels.

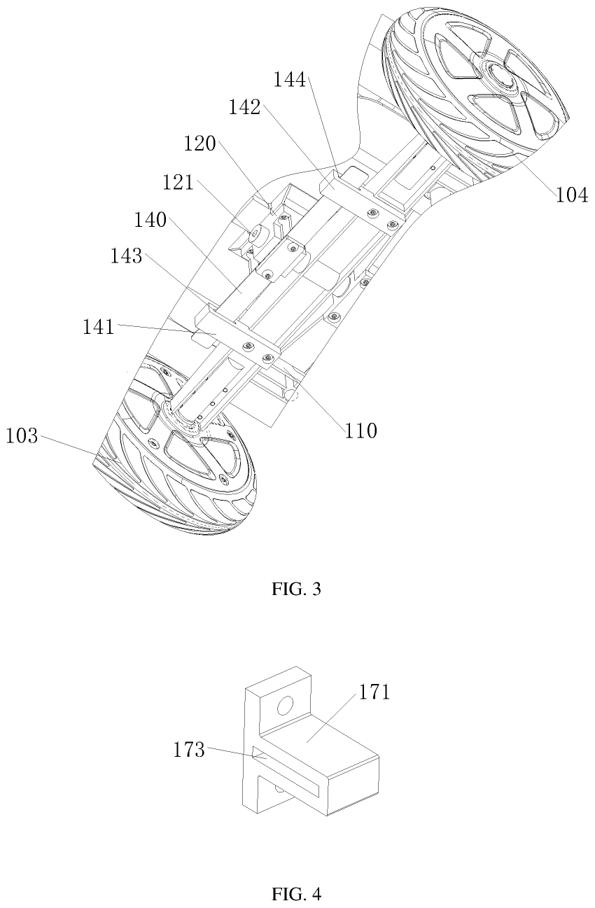

In some optional implementation modes of the embodiment, as illustrated in FIG. 2 and FIG. 3, in order to prevent the first crossbeam 130 from rotating too much around the first rotating shaft 121 to affect the smooth moving of the chassis, the chassis further includes a first plate spring 140, the middle of which is fixed on the first suspension seat 120. The two sides, relative to the first suspension seat 120, of the first crossbeam 130 are respectively provided with a first position limiting seat 141 and a second position limiting seat 142. The first position limiting seat 141 is provided with a first through groove 143 mating with the first end of the first plate spring 140, and the second position limiting seat 142 is provided with a second through groove 144 mating with the second end of the first plate spring 140. The first end of the first plate spring 140 is inserted in the first through groove 143 and is capable of sliding in the first through groove 143. The second end of the first plate spring 140 is inserted in the second through groove 144 and is capable of sliding in the second through groove 144.

Here, the way of fixing the middle of the first plate spring 140 on the first suspension seat 120 is not limited. The middle of the first plate spring 140 may be welded on the first suspension seat 120, and may also be fixed on the first suspension seat 120 by a screw. FIG. 3 exemplarily illustrates that the middle of the first plate spring 140 is fixed on the first suspension seat 120 by a screw. The position where the middle of the first plate spring 140 is fixed on the first suspension seat 120 is not limited. FIG. 3 exemplarily illustrates that the first rotating shaft 121 is arranged at one side of the first suspension seat 120, and the middle of the first plate spring 140 is fixed on the bottom side of the first suspension seat 120.

Here, the cross-section shape of the first end of the first plate spring 140 may be a triangle, and may also be a trapezoid. The cross-section shape of the second end of the first plate spring 140 and the cross-section shape of the first end of the first plate spring 140 may be the same, and may also be different. FIG. 3 exemplarily illustrates that the cross-section shape of the first end of the first plate spring 140 and the cross-section shape of the second end of the first plate spring 140 are the same, and are all rectangles.

As illustrated in FIG. 3, the way of arranging the first position limiting seat 141 at one side of the first crossbeam 130 is not limited. The first position limiting seat 141 is provided with the first through groove 143 mating with the first end of the first plate spring 140. Here, the cross-section shape of the first through groove 143 may be set according to actual needs, as long as the first end of the first plate spring 140 may be inserted in the first through groove 143, and may slide in the first through groove 143. The way of arranging the second position limiting seat 142 at the other side of the first crossbeam 130 is not limited. The second position limiting seat 142 is provided with the second through groove 144 mating with the second end of the first plate spring 140. Here, the cross-section shape of the second through groove 144 may be set according to actual needs, as long as the second end of the first plate spring 140 may be inserted in the second through groove 144, and may slide in the second through groove 144.

FIG. 3 exemplarily illustrates that the structure of the first position limiting seat 141 and the structure of the second position limiting seat 142 are the same, and they are fixed on the first crossbeam 130 by a bolt. The cross-section shape of the first end of the first plate spring 140 and the cross-section shape of the first through groove 143 are the same, and are all rectangles. The cross-section shape of the first through groove 143 and the cross-section shape of the second through groove 144 are the same, and are all rectangles.

In some optional implementation modes of the embodiment, as illustrated in FIG. 4 to FIG. 8, the top side of the support 110 is provided with a connecting seat on which a connecting shaft is provided. The axis of the connecting shaft is vertical to the axis of the first rotating shaft 121. The chassis further includes a supporting bracket 150. The rear side of the supporting bracket 150 is provided with a wheel set. The middle of the supporting bracket 150 is connected with the connecting shaft and is capable of rotating around the connecting shaft. When the support pulls, by means of the connecting shaft, the supporting bracket 150 to move over the supporting surface, the wheel set rotates around the connecting shaft by means of the supporting bracket 150 to make contact with the supporting surface.

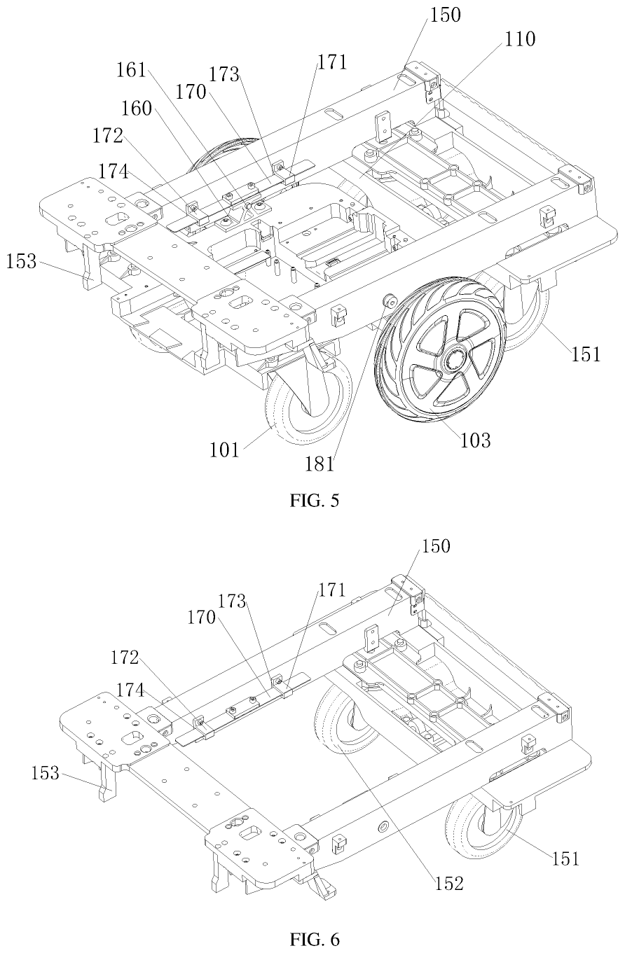

In the implementation mode, the supporting bracket 150 is used for supporting goods. The goods may be placed on the supporting bracket 150, and the support 110 pulls the goods on the supporting bracket 150 by means of the connecting shaft. When the state of the supporting surface changes, the wheel set rotates around the connecting shaft by means of the supporting bracket 150 to make contact with the supporting surface, so as to ensure the wheel set of the supporting bracket 150 to provide a stable supporting force for the supporting bracket 150. The structure and shape of the supporting bracket 150 may be set according to actual needs. As an example, as illustrated in FIG. 5 to FIG. 7, the front end of the supporting bracket 150 is provided with a clamping hook 153. The first end of the support 110 is clamped at the inner side of the clamping hook 153, and there is a preset distance between the first end of the support 110 and the clamping hook 153. When the preset distance satisfies that the supporting bracket 150 rotates around the connecting shaft, the first end of the support 110 does not collide with the clamping hook 153.

In the implementation mode, the axis of the connecting shaft is vertical to the axis of the first rotating shaft 121, that is, the connecting shaft is vertical to the first rotating shaft 121. When the chassis is moving, the first crossbeam 130 rotates left and right, and the supporting bracket 150 rotates forward and backward, so as to ensure that the chassis may enable all the wheels to contact with the supporting surface when the state of the supporting surface changes. In this way, not only the adaptability of the chassis to the supporting surface is improved, but also an effective supporting area between the chassis and the supporting surface is increased, thus not only the stability of the whole chassis is improved, but also the loading capacity of the whole chassis is improved. Meanwhile, when the chassis moves from the flat supporting surface to a slope surface, the wheels, at the front side of the chassis, of the support 110 contact with the slope surface first, the wheels, at the rear side of the chassis, of the support 110 will pass through the flat supporting surface and the slope surface successively, and the wheel set of the supporting bracket 150 will also pass through the flat supporting surface and the slope surface successively by means of that the supporting bracket 150 rotates around the connecting shaft, which will not make the wheels, at the rear side of the chassis, of the support 110 get out of contact with the supporting surface, so the problem in the prior art that the middle wheel gets out of contact with the supporting surface when the chassis rigidly supported by multiple wheels climb is solved. Therefore, the chassis has the ability of passing over the slope surfaces and uneven road surfaces. Besides, the supporting bracket 150 and the support 110 are in overlap and staggered joint, the gravity borne by the supporting bracket 150 is distributed over all the wheels, and when the chassis climbs over obstacles, the center of gravity proportionally climbs step by step, thereby reducing a torque requirement on the driving wheel, and improving the overall ability of overcoming obstacles with load of the chassis.

The wheel set in the implementation mode may include a wheel, and may also include multiple wheels. FIG. 5 to FIG. 7 exemplarily illustrate that the wheel set includes a fifth wheel 151 and a sixth wheel 152. The fifth wheel 151 and the sixth wheel 152 are arranged at two sides of the rear end of the supporting bracket 150. The first wheel 101, the second wheel 102, the third wheel 103, the fourth wheel 104, the fifth wheel 151 and the sixth wheel 152 are evenly distributed in two rows. The wheel set is used for supporting the rear end of the supporting bracket 150, so that the supporting bracket 150 moves over the supporting surface by means of the wheel set when the support 110 pulls, by means of the connecting shaft, the supporting bracket 150 to move over the supporting surface. When the two sides of the rear end of the supporting bracket 150 are provided with the fifth wheel 151 and the sixth wheel 152, the fifth wheel 151 and the sixth wheel 152 are simultaneously used for supporting the rear end of the supporting bracket 150, so it is more reliable for the supporting bracket 150 to move over the supporting surface by means of the fifth wheel 151 and the sixth wheel 152. It is understandable that the chassis here is provided with six wheels, and the effective supporting area between the chassis and the supporting surface may be increased by means of the six wheels, thereby improving the loading capacity of the whole chassis.

In the implementation mode, when the wheel set includes the fifth wheel 151 and the sixth wheel 152, the fifth wheel 151 and the sixth wheel 152 may be arranged on the rear end of the supporting bracket 150 directly, and may also be arranged on the rear end of the supporting bracket 150 by means of other structures. That the fifth wheel 151 and the sixth wheel 152 are arranged on the rear end of the supporting bracket 150 is exemplarily listed below.

For example, the fifth wheel 151 and the sixth wheel 152 are arranged on the rear end of the supporting bracket 150 by means of a second suspension seat. As illustrated in FIG. 9, the chassis includes: the second suspension seat 154 arranged at the bottom side of the rear end of the supporting bracket 150, a second rotating shaft 155 arranged on the second suspension seat 154, a second crossbeam 156 connected with the second rotating shaft 155 and being capable of rotating around the second rotating shaft 155, and the fifth wheel 151 and the sixth wheel 152 arranged on two ends of the second crossbeam 156. The axis of the second rotating shaft 155 is consistent with the moving direction of the chassis. There is a connecting structure arranged between the supporting bracket 150 and the chassis. When the chassis pulls, by means of the connecting structure, the supporting bracket 150 to move over the supporting surface, and the state of the supporting surface changes and one of the fifth wheel 151 and the sixth wheel 152 gets out of contact with the supporting surface, the out-of-contact one of the fifth wheel 151 and the sixth wheel 152 can rotate around the second rotating shaft 155 by means of the second crossbeam 156 to make contact with the supporting surface.

In the embodiment, the axis of the second rotating shaft 155 is consistent with the moving direction of the chassis; when the chassis pulls, by means of the connecting structure, the supporting bracket 150 to move over the supporting surface, and the state of the supporting surface changes and one of the fifth wheel 151 and the sixth wheel 152 gets out of contact with the supporting surface, the out-of-contact one of the fifth wheel 151 and the sixth wheel 152 can rotate around the second rotating shaft 155 by means of the second crossbeam 156 to make contact with the supporting surface, so the problem of over-positioning of the supporting bracket 150 rigidly supported by two wheels may be solved, and it is ensured that the two wheels of the supporting bracket 150 contact with the supporting surface in the moving process.

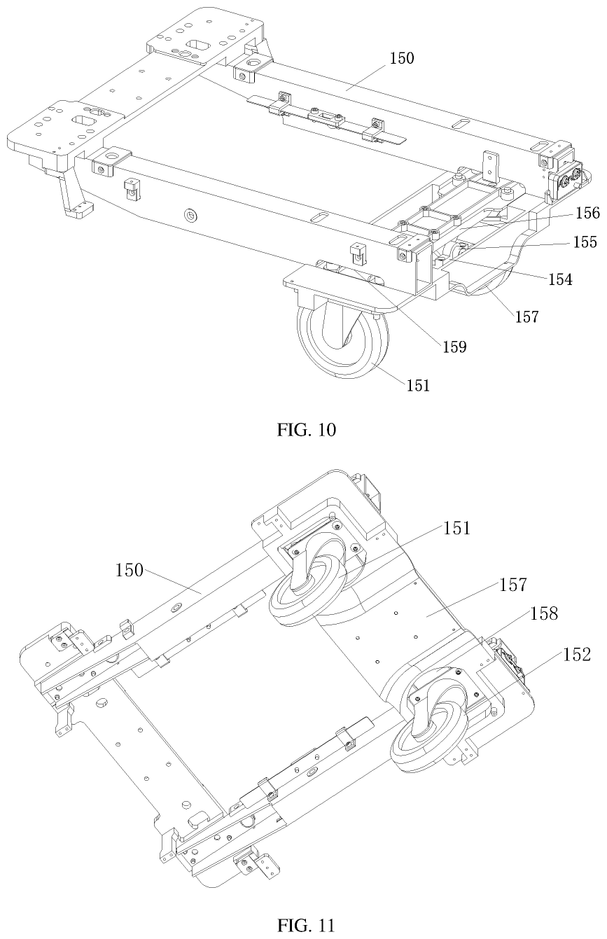

In the example, the second suspension seat 154 may be directly arranged on the supporting bracket 150. Here, the way of arranging the second suspension seat 154 may be the same as the way of arranging the first suspension seat 120 illustrated in FIG. 2 and FIG. 3. The second suspension seat 154 may also be arranged on the supporting bracket 150 by means of other structures. That the second suspension seat 154 is arranged on the supporting bracket 150 by means of a supporting plate 157 is exemplarily listed below. For example, as illustrated in FIG. 9 to FIG. 11, the chassis further includes the supporting plate 157 arranged at the bottom side of the rear end of the supporting bracket 150, and an accommodating space arranged at the top side of the supporting plate 157. The second suspension seat 154 is arranged at the top side of the supporting plate 157 and in the accommodating space. The positions, corresponding to the fifth wheel 151 and the sixth wheel 152, of the supporting plate 157 are respectively provided with openings 158. The fifth wheel 151 and the sixth wheel 152 are at the bottom side of the supporting plate 157 after passing through respective openings 158; and the second crossbeam 156 can rotate in the accommodating space around the second rotating shaft 155. As an example, as illustrated in FIG. 10, in order to prevent the second crossbeam 156 from rotating too much around the second rotating shaft 155 to affect the smooth moving of the supporting bracket 150, the chassis further includes position limiting slots 159 arranged at the bottom side of the rear end of the supporting bracket 150 and respectively mating with two ends of the second crossbeam 156. The two ends of the second crossbeam 156 are inserted in respective position limiting slots 159, and there are preset clearances formed between the two ends of the second crossbeam 156 and the position limiting slots 159 in the rotating direction. When the second crossbeam 156 rotates in the accommodating space around the second rotating shaft 155, the two ends of the second crossbeam limit a rotation angle of the second crossbeam by means of the position limiting slots 159. Here, the shape of the position limiting slots 159 may be set according to the shape of the two ends of the second crossbeam 156, as long as there are preset clearances respectively formed between the two ends of the second crossbeam 156 and the position limiting slots 159 in the rotating direction, so that the two ends of the second crossbeam 156 rotate in the position limiting slots 159. FIG. 10 exemplarily illustrates that the cross section of the position limiting slots 159 is a rectangle, and the cross section of the two ends of the second crossbeam 156 is also a rectangle.

In the implementation mode, the number of the connecting seats may be one or more than one. When the number of the connecting seats is one, the number of the connecting shafts is also one, and the middle of the supporting bracket 150 rotates around one connecting shaft; when the number of the connecting seats is more than one, each connecting seat is provided with one connecting shaft, and the middle of the supporting bracket 150 rotates around each connecting shaft. It is to be noted that when the number of the connecting seats is more than one, the axes of the connecting shafts of each connecting seat are collinear.

For example, FIG. 5 to FIG. 7 exemplarily illustrate that the connecting seat includes a first connecting seat 180 and a second connecting seat 160 arranged at opposite sides of the top side of the support 110. The connecting shaft includes a first connecting shaft 181 arranged on the first connecting seat 180 and a second connecting shaft 161 arranged on the second connecting seat 160. The axis of the first connecting shaft 181 is vertical to the axis of the first rotating shaft 121; and the axis of the first connecting shaft 181 is collinear with the axis of the second connecting shaft 161. Two sides of the middle of the supporting bracket 150 are respectively provided with a first connecting hole mating with the first connecting shaft 181 and a second connecting hole mating with the second connecting shaft 161. The first connecting shaft 181 is arranged in the first connecting hole, and the first connecting shaft 181 is in clearance fit with the first connecting hole. The second connecting shaft 161 is arranged in the second connecting hole, and the second connecting shaft 161 is in clearance fit with the second connecting hole. When the support 110 pulls, by means of the first connecting shaft 181 and the second connecting shaft 161, the supporting bracket 150 to move over the supporting surface, the wheel set rotates around the first connecting shaft 181 and the second connecting shaft 161 by means of the supporting bracket 150 to make contact with the supporting surface.

In the example, the specific positions of the first connecting seat 180 and the second connecting seat 160 on the top side of the support 110 are not limited. For example, as illustrated in FIG. 5 to FIG. 7, the first connecting seat 180 and the second connecting seat 160 are respectively at the opposite sides of the top side of the second end of the support 110, and the front end of the supporting bracket 150 is correspondingly at the top side of the first end of the support, and the third wheel and the fourth wheel are arranged at the middle of the supporting bracket; correspondingly, the wheel set may include the fifth wheel 151 and the sixth wheel 152, and the fifth wheel 151 and the sixth wheel 152 are arranged at the two sides of the rear end of the supporting bracket. The third wheel 103 and the fourth wheel 104 arranged at the middle of the supporting bracket are the driving wheels, and the first wheel 101, the second wheel 102, the fifth wheel 151 and the sixth wheel 152 are the drive wheels. The distances from center between the third wheel 103 and the fourth wheel 104 to the first wheel 101, the second wheel 102, the fifth wheel 151 and the sixth wheel 152 are equal, and the center between the third wheel 103 and the fourth wheel 104 is at an intersection of two diagonals formed by the first wheel 101, the second wheel 102, the fifth wheel 151 and the sixth wheel 152. For another example, the first connecting seat 180 and the second connecting seat 160 are respectively at the opposite sides of the top side of the second end of the support 110, the front end of the supporting bracket is correspondingly at the top side of the second end of the support 110, and the first wheel 101 and the second wheel 102 are arranged at the middle of the supporting bracket 150; correspondingly, the first wheel 101 and the second wheel 102 arranged at the middle of the supporting bracket 150 are the driving wheels, the third wheel 103, the fourth wheel 104, the fifth wheel 151 and the sixth wheel 152 are the driven wheels. The distances from center between the first wheel 101 and the second wheel 102 to the third wheel 103, the fourth wheel 104, the fifth wheel 151 and the sixth wheel 152 are equal, and the center between the first wheel 101 and the second wheel 102 is at an intersection of two diagonals formed by the third wheel 103, the fourth wheel 104, the fifth wheel 151 and the sixth wheel 152. When the wheel arranged at the middle of the supporting bracket 150 is the driving wheel, the chassis becomes a six-wheel chassis where the driving wheel is arranged at the middle. The advantage of arranging the driving wheel arranged at the middle is that the chassis needs only two driving wheels to achieve pivot steering with a zero turning radius. In the rotating process of the four-wheel chassis illustrated in FIG. 1, its turning sweep space of steering sweep is a circle taking the symmetric center of the two driving wheels as the center and taking the distance between the driving wheel and the driven wheel as the radius; here, the turning sweep space of steering sweep of the six-wheel chassis where the driving wheel is arranged at the middle is the same as the turning sweep space of the four-wheel chassis, and the supporting surface of the six-wheel chassis where the driving wheel is arranged at the middle is doubled, so the loading capacity of the chassis is improved to an extreme in the same driving space. Certainly, the distances from the center between the driving wheels arranged at the middle of the supporting bracket 150 to the fifth wheel 151 and the sixth wheel 152 may also be less than the distances from the center between the driving wheels arranged at the middle of the supporting bracket 150 to the driven wheels on the front end of the supporting bracket 150. The turning sweep space of such a six-wheel chassis where the driving wheel is arranged at the middle is the same as the turning sweep space of the four wheel chassis, and the supporting surface of the six-wheel chassis where the driving wheel is arranged at the middle may also be increased, so the loading capacity of the chassis is improved.

In the example, the structure of the first connecting seat 180 and the structure of the second connecting seat 160 may be the same, and may also be different. The structure of the first connecting shaft 181 and the structure of the second connecting shaft 161 here may be the same, and may also be different. FIG. 5 to FIG. 7 exemplarily illustrate that the structure of the first connecting seat 180 and the structure of the second connecting seat 160 are the same, and the structure of the first connecting shaft 181 and the structure of the second connecting shaft 161 are the same. So, it is convenient for production and processing.

In the implementation mode, in order to prevent the supporting bracket 150 from rotating too much around the connecting shaft to affect the smooth moving of the chassis, the chassis may also include the plate spring. The plate spring here is used for preventing the supporting bracket 150 from rotating too much around the connecting shaft. The way of arranging the plate spring here and the way of arranging the first plate spring 140 may be the same, and may also be different.

For example, as illustrated in FIG. 4 to FIG. 8, when the supporting bracket 150 is connected with the support 110 by means of the first connecting shaft 181 and the second connecting shaft 161, the chassis further includes a second plate spring and a third plate spring 170. The middle of the second plate spring is fixed on the first connecting seat 180. Two sides of the supporting bracket 150 with respect to the first connecting seat 180 are respectively provided with a third position limiting seat and a fourth position limiting seat. The third position limiting seat is provided with a third through groove mating with the first end of the second plate spring, and the fourth position limiting seat is provided with a fourth through groove mating with the second end of the second plate spring. The first end of the second plate spring is inserted in the third through groove and is capable of sliding in the third through groove, and the second end of the second plate spring is inserted in the fourth through groove and is capable of sliding in the fourth through groove. The middle of the third plate spring 170 is fixed on the second connecting seat 160. Two sides of the supporting bracket 150 with respect to the second connecting seat 160 are respectively provided with a fifth position limiting seat 171 and a sixth position limiting seat 172. The fifth position limiting seat 171 is provided with a fifth through groove 173 mating with the first end of the third plate spring 170, and the sixth position limiting seat 172 is provided with a sixth through groove 174 mating with the second end of the third plate spring 170. The first end of the third plate spring 170 is inserted in the fifth through groove 173 and is capable of sliding in the fifth through groove 173, and the second end of the third plate spring 170 is inserted in the sixth through groove 174 and is capable of sliding in the sixth through groove 174.

Here, the middle of the second plate spring, the first end of the second plate spring, the second end of the second plate spring, the third position limiting seat, the fourth position limiting seat, the third through groove and the fourth through groove respectively correspond to the middle of the first plate spring 140, the first end of the first plate spring 140, the second end of the first plate spring 140, the first position limiting seat 141, the second position limiting seat 142, the first through groove 143 and the second through groove 144. The above descriptions of the middle of the first plate spring 140, the first end of the first plate spring 140, the second end of the first plate spring 140, the first position limiting seat 141, the second position limiting seat 142, the first through groove 143 and the second through groove 144 are also adaptable to the middle of the second plate spring, the first end of the second plate spring, the second end of the second plate spring, the third position limiting seat, the fourth position limiting seat, the third through groove and the fourth through groove, and will not be repeated here.

Here, the middle of the third plate spring 170, the first end of the third plate spring 170, the second end of the third plate spring 170, the fifth position limiting seat 171, the sixth position limiting seat 172, the fifth through groove 173 and the sixth through groove 174 respectively correspond to the middle of the first plate spring 140, the first end of the first plate spring 140, the second end of the first plate spring 140, the first position limiting seat 141, the second position limiting seat 142, the first through groove 143 and the second through groove 144. The above descriptions of the middle of the first plate spring 140, the first end of the first plate spring 140, the second end of the first plate spring 140, the first position limiting seat 141, the second position limiting seat 142, the first through groove 143 and the second through groove 144 are also adaptable to the middle of the third plate spring 170, the first end of the third plate spring 170, the second end of the third plate spring 170, the fifth position limiting seat 171, the sixth position limiting seat 172, the fifth through groove 173 and the sixth through groove 174, and will not be repeated here.

In the embodiments of the present disclosure, when the state of the supporting surface changes and one of the third wheel 103 and the fourth wheel 104 gets out of contact with the supporting surface, the out-of-contact one of the third wheel 103 and the fourth wheel 104 can rotate around the first rotating shaft 121 by means of the first crossbeam 130 to make contact with the supporting surface. The embodiments solve the problem of over-positioning phenomenon occurring between the chassis rigidly supported by four wheels and the supporting surface, so that the four wheels can contact with the supporting surface in the moving process, thus the running stability and security of the vehicle in moving is improved.

The embodiments of the present disclosure also provide a robot. The robot includes the chassis recorded in the above embodiments.

The above is only the specific implementation mode of the application and not intended to limit the scope of protection of the application. Any variations or replacements apparent to those skilled in the art within the technical scope disclosed by the application shall fall within the scope of protection of the application. Therefore, the scope of protection of the present disclosure shall be subject to the scope of protection of the claims.

1. An adaptive chassis, comprising: a support, a first wheel and a second wheel arranged at two sides of a first end of the support, a first suspension seat arranged at a bottom side of a second end of the support, a first rotating shaft arranged on the first suspension seat, a first crossbeam connected with the first rotating shaft and being capable of rotating around the first rotating shaft, and a third wheel and a fourth wheel arranged on two ends of the first crossbeam,
wherein an axis of the first rotating shaft is consistent with a moving direction of the chassis; and
when a state of a supporting surface changes and one of the third wheel and the fourth wheel gets out of contact with the supporting surface, the out-of-contact one of the third wheel and the fourth wheel can rotate around the first rotating shaft by means of the first crossbeam to make contact with the supporting surface.

2. The chassis of claim 1, further comprising a first plate spring, a middle of which is fixed on the first suspension seat; two sides of the first crossbeam with respect to the first suspension seat are respectively provided with a first position limiting seat and a second position limiting seat, wherein the first position limiting seat is provided with a first through groove mating with a first end of the first plate spring, and the second position limiting seat is provided with a second through groove mating with a second end of the first plate spring, and
wherein the first end of the first plate spring is inserted in the first through groove and is capable of sliding in the first through groove, and the second end of the first plate spring is inserted in the second through groove and is capable of sliding in the second through groove.

3. The chassis of claim 1, wherein the first wheel and the second wheel are driving wheels, and the third wheel and the fourth wheel are driven wheels; or
the third wheel and the fourth wheel are the driving wheels, and the first wheel and the second wheel are the driven wheels; or
all of the first wheel, the second wheel, the third wheel and the fourth wheel are the driving wheels.

4. The chassis of claim 3, wherein each driven wheel is a universal wheel, and a middle of each driving wheel is provided with a wheel hub motor.

5. The chassis of claim 1, wherein a connecting seat is arranged at a top side of the support, a connecting shaft being arranged on the connecting seat, and an axis of the connecting shaft being vertical to the axis of the first rotating shaft; and
the chassis further comprises a supporting bracket, a wheel set being arranged on a rear end of the supporting bracket, and a middle of the supporting bracket being connected with the connecting shaft and capable of rotating around the connecting shaft,
wherein when the support pulls, by means of the connecting shaft, the supporting bracket to move over the supporting surface, the wheel set rotates around the connecting shaft by means of the supporting bracket to make contact with the supporting surface.

6. The chassis of claim 5, wherein the connecting seat comprises a first connecting seat and a second connecting seat arranged at opposite sides of the top side of the support; the connecting shaft comprises a first connecting shaft arranged on the first connecting seat and a second connecting shaft arranged on the second connecting seat; an axis of the first connecting shaft is vertical to the axis of the first rotating shaft; and an axis of the first connecting shaft is collinear with an axis of the second connecting shaft;
two sides of the middle of the supporting bracket are respectively provided with a first connecting hole mating with the first connecting shaft and a second connecting hole mating with the second connecting shaft; the first connecting shaft is arranged in the first connecting hole, and the first connecting shaft is in clearance fit with the first connecting hole; the second connecting shaft is arranged in the second connecting hole, and the second connecting shaft is in clearance fit with the second connecting hole;
when the support pulls, by means of the first connecting shaft and the second connecting shaft, the supporting bracket to move over the supporting surface, the wheel set rotates around the first connecting shaft and the second connecting shaft by means of the supporting bracket to make contact with the supporting surface.

7. The chassis of claim 6, further comprising a second plate spring and a third plate spring,
wherein a middle of the second plate spring is fixed on the first connecting seat; two sides of the supporting bracket with respect to the first connecting seat are respectively provided with a third position limiting seat and a fourth position limiting seat; the third position limiting seat is provided with a third through groove mating with a first end of the second plate spring, and the fourth position limiting seat is provided with a fourth through groove mating with a second end of the second plate spring; the first end of the second plate spring is inserted in the third through groove and is capable of sliding in the third through groove, and the second end of the second plate spring is inserted in the fourth through groove and is capable of sliding in the fourth through groove;
a middle of the third plate spring is fixed on the second connecting seat; two sides of the supporting bracket with respect to the second connecting seat are respectively provided with a fifth position limiting seat and a sixth position limiting seat; the fifth position limiting seat is provided with a fifth through groove mating with a first end of the third plate spring, and the sixth position limiting seat is provided with a sixth through groove mating with a second end of the third plate spring; the first end of the third plate spring is inserted in the fifth through groove and is capable of sliding in the fifth through groove, and the second end of the third plate spring is inserted in the sixth through groove and is capable of sliding in the sixth through groove.

8. The chassis of claim 6, wherein the first connecting seat and the second connecting seat are respectively at opposite sides of a top side of a second end of the support; a front end of the supporting bracket is correspondingly at a top side of the first end of the support, and the third wheel and the fourth wheel are arranged at the middle of the supporting bracket; or,
the first connecting seat and the second connecting seat are respectively at the opposite sides of the top side of the first end of the support; the front end of the supporting bracket is correspondingly at the top side of the second end of the support, and the first wheel and the second wheel are arranged at the middle of the supporting bracket.

9. The chassis of claim 8, wherein the wheel set comprises a fifth wheel and a sixth wheel; the fifth wheel and the sixth wheel are arranged at two sides of the rear end of the supporting bracket;
the third wheel and the fourth wheel arranged at the middle of the supporting bracket are the driving wheels, and the first wheel, the second wheel, the fifth wheel and the sixth wheel are the driven wheels; distances from a center between the third wheel and the fourth wheel to the first wheel, the second wheel, the fifth wheel and the sixth wheel are equal, and the center between the third wheel and the fourth wheel is at an intersection of two diagonals formed by the first wheel, the second wheel, the fifth wheel and the sixth wheel; or
the first wheel and the second wheel arranged at the middle of the supporting bracket are the driving wheels, and the third wheel, the fourth wheel, the fifth wheel and the sixth wheel are the driven wheels; distances from a center between the first wheel and the second wheel to the third wheel, the fourth wheel, the fifth wheel and the sixth wheel are equal, and the center between the first wheel and the second wheel is at an intersection of two diagonals formed by the third wheel, the fourth wheel, the fifth wheel and the sixth wheel.

10. The chassis of claim 5, further comprising a second suspension seat arranged at a bottom side of the rear end of the supporting bracket, a second rotating shaft arranged on the second suspension seat, and a second crossbeam connected with the second rotating shaft and being capable of rotating around the second rotating shaft; the wheel set comprises a fifth wheel and a sixth wheel arranged on two ends of the second crossbeam,
wherein an axis of the second rotating shaft is consistent with the moving direction of the chassis;
when the support pulls, by means of the connecting shaft, the supporting bracket to move over the supporting surface, and when the state of the supporting surface changes and one of the fifth wheel and the sixth wheel gets out of contact with the supporting surface, the out-of-contact one of the fifth wheel and the sixth wheel can rotate around the second rotating shaft by means of the second crossbeam to make contact with the supporting surface.

11. The chassis of claim 10, further comprising a supporting plate arranged at the bottom side of the rear end of the supporting bracket, and an accommodating space arranged at a top side of the supporting plate,
wherein the second suspension seat is arranged at the top side of the supporting plate and in the accommodating space; positions, corresponding to the fifth wheel and the sixth wheel, of the supporting plate are respectively provided with openings; the fifth wheel and the sixth wheel are at the bottom side of the supporting plate after passing through respective openings; and the second crossbeam can rotate in the accommodating space around the second rotating shaft.

12. The chassis of claim 11, further comprising position limiting slots arranged at the bottom side of the rear end of the supporting bracket and respectively mating with two ends of the second crossbeam; the two ends of the second crossbeam are inserted in respective position limiting slots, and preset clearances are formed between the two ends of the second crossbeam and the respective position limiting slots in a rotating direction of the second crossbeam,
wherein when the second crossbeam rotates in the accommodating space around the second rotating shaft, the two ends of the second crossbeam limit a rotation angle of the second crossbeam by means of the position limiting slots.

13. A robot, comprising an adaptive chassis, the adaptive chassis comprising: a support, a first wheel and a second wheel arranged at two sides of a first end of the support, a first suspension seat arranged at a bottom side of a second end of the support, a first rotating shaft arranged on the first suspension seat, a first crossbeam connected with the first rotating shaft and being capable of rotating around the first rotating shaft, and a third wheel and a fourth wheel arranged on two ends of the first crossbeam,
wherein an axis of the first rotating shaft is consistent with a moving direction of the chassis; and
when a state of a supporting surface changes and one of the third wheel and the fourth wheel gets out of contact with the supporting surface, the out-of-contact one of the third wheel and the fourth wheel can rotate around the first rotating shaft by means of the first crossbeam to make contact with the supporting surface.

14. The robot of claim 13, wherein the chassis further comprises a first plate spring, a middle of which is fixed on the first suspension seat; two sides of the first crossbeam with respect to the first suspension seat are respectively provided with a first position limiting seat and a second position limiting seat, wherein the first position limiting seat is provided with a first through groove mating with a first end of the first plate spring, and the second position limiting seat is provided with a second through groove mating with a second end of the first plate spring, and
wherein the first end of the first plate spring is inserted in the first through groove and is capable of sliding in the first through groove, and the second end of the first plate spring is inserted in the second through groove and is capable of sliding in the second through groove.

15. The robot of claim 13, wherein the first wheel and the second wheel are driving wheels, and the third wheel and the fourth wheel are driven wheels; or
the third wheel and the fourth wheel are the driving wheels, and the first wheel and the second wheel are the driven wheels; or
all of the first wheel, the second wheel, the third wheel and the fourth wheel are the driving wheels.

16. The robot of claim 15, wherein each driven wheel is a universal wheel, and a middle of each driving wheel is provided with a wheel hub motor.

17. The robot of claim 13, wherein a connecting seat is arranged at a top side of the support, a connecting shaft being arranged on the connecting seat, and an axis of the connecting shaft being vertical to the axis of the first rotating shaft; and
the chassis further comprises a supporting bracket, a wheel set being arranged on a rear end of the supporting bracket, and a middle of the supporting bracket being connected with the connecting shaft and capable of rotating around the connecting shaft,
wherein when the support pulls, by means of the connecting shaft, the supporting bracket to move over the supporting surface, the wheel set rotates around the connecting shaft by means of the supporting bracket to make contact with the supporting surface.

18. The robot of claim 17, wherein the connecting seat comprises a first connecting seat and a second connecting seat arranged at opposite sides of the top side of the support; the connecting shaft comprises a first connecting shaft arranged on the first connecting seat and a second connecting shaft arranged on the second connecting seat; an axis of the first connecting shaft is vertical to the axis of the first rotating shaft; and an axis of the first connecting shaft is collinear with an axis of the second connecting shaft;
two sides of the middle of the supporting bracket are respectively provided with a first connecting hole mating with the first connecting shaft and a second connecting hole mating with the second connecting shaft; the first connecting shaft is arranged in the first connecting hole, and the first connecting shaft is in clearance fit with the first connecting hole; the second connecting shaft is arranged in the second connecting hole, and the second connecting shaft is in clearance fit with the second connecting hole;
when the support pulls, by means of the first connecting shaft and the second connecting shaft, the supporting bracket to move over the supporting surface, the wheel set rotates around the first connecting shaft and the second connecting shaft by means of the supporting bracket to make contact with the supporting surface.

19. The robot of claim 18, wherein the chassis further comprises a second plate spring and a third plate spring,
wherein a middle of the second plate spring is fixed on the first connecting seat; two sides of the supporting bracket with respect to the first connecting seat are respectively provided with a third position limiting seat and a fourth position limiting seat; the third position limiting seat is provided with a third through groove mating with a first end of the second plate spring, and the fourth position limiting seat is provided with a fourth through groove mating with a second end of the second plate spring; the first end of the second plate spring is inserted in the third through groove and is capable of sliding in the third through groove, and the second end of the second plate spring is inserted in the fourth through groove and is capable of sliding in the fourth through groove;
a middle of the third plate spring is fixed on the second connecting seat; two sides of the supporting bracket with respect to the second connecting seat are respectively provided with a fifth position limiting seat and a sixth position limiting seat; the fifth position limiting seat is provided with a fifth through groove mating with a first end of the third plate spring, and the sixth position limiting seat is provided with a sixth through groove mating with a second end of the third plate spring; the first end of the third plate spring is inserted in the fifth through groove and is capable of sliding in the fifth through groove, and the second end of the third plate spring is inserted in the sixth through groove and is capable of sliding in the sixth through groove.

20. The robot of claim 18, wherein the first connecting seat and the second connecting seat are respectively at opposite sides of a top side of a second end of the support; a front end of the supporting bracket is correspondingly at a top side of the first end of the support, and the third wheel and the fourth wheel are arranged at the middle of the supporting bracket; or,
the first connecting seat and the second connecting seat are respectively at the opposite sides of the top side of the first end of the support; the front end of the supporting bracket is correspondingly at the top side of the second end of the support, and the first wheel and the second wheel are arranged at the middle of the supporting bracket.
